(19) United States
(12) Patent Application Publication
(10) Pub. No.: US 2008/0182557 A1
(43) Pub. Date: Jul. 31, 2008

(54) INFORMATION PROCESSING APPARATUS, STATUS CHANGE SYSTEM AND PROGRAM FOR THE SAME

(75) Inventor: KATSUTOSHI KATO, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/017,727

(22) Filed: Jan. 22, 2008

(30) Foreign Application Priority Data
Jan. 31, 2007 (JP) 2007-022253

(51) Int. Cl. H04M 3/22

(52) U.S. Cl. 455/411

(57) ABSTRACT

According to one embodiment, an information processing apparatus includes an authenticating unit which authenticates a cellular telephone includes a short-distance wireless communications unit, via the short-distance wireless communications unit, a detecting unit which detects whether or not the cellular telephone authenticated by the authenticating unit is in a predetermined range from the information processing apparatus, a first changing unit which, if it is discriminated by the detecting unit that the authenticated cellular telephone is not in the predetermined range, changes a status retained by the application from a first status to a second status, and a second changing unit which, if it is discriminated by the detecting unit that the authenticated cellular telephone is in the predetermined range, changes the status retained by the application from the second status to the first status.

### CROSS-REFERENCE TO RELATED APPLICATIONS

This application is based upon and claims the benefit of priority from Japanese Patent Application No. 2007-022253, filed Jan. 31, 2007, the entire contents of which are incorporated herein by reference.

### BACKGROUND

1. Field

One embodiment of the invention relates to an information processing apparatus such as a personal computer equipped with an application for automatically changing the status of real-time communications software, the status change system and program for the same.

2. Description of the Related Art

In general, requests for convenience of personal computers have been increased. For example, a technique of, when a user leaves its seat and does not operate a computer, detecting a user's leaving time with an infrared sensor and changing the computer to a predetermined processing status, has been disclosed for example, Jpn. Pat. Appln. KOKAI Publication No. 2004-213323.

According to the technique of Jpn. Pat. Appln. KOKAI Publication No. 2004-213323, however, security of the computer is not retained, or it cannot be discriminated whether the user is in the seat if the user is located in the vicinity of the computer but is not in the direction of the infrared sensor. Moreover, every time the user using communications software employing VOIP (Voice Over Internet Protocol) whose usage has been recently increased leaves the seat temporarily, the user needs to manually change the status of the communications software from “on-line (in seat)” to “leaving”.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a cellular telephone and an information processing apparatus according to an embodiment of a status change system of the present invention;

FIG. 2 is a block diagram showing a system configuration of the information processing apparatus according to the embodiment of the present invention;

FIG. 3 is a block diagram showing functions of a VOIP application;

FIG. 4 is an illustration of the VOIP application; and

FIG. 5 is a flowchart of a control method and program to which the status change system and the information processing apparatus according to the embodiment of the present invention are applied.

### DETAILED DESCRIPTION

Various embodiments according to the invention will be described hereinafter with reference to the accompanying drawings. In general, according to one embodiment of the invention, an information processing apparatus in which an application for connecting to a network and executing real-time communications is installed, comprises: an authenticating unit which authenticates a cellular telephone equipped with a short-distance wireless communications unit, via the short-distance wireless communications unit; a detecting unit which detects whether or not the cellular telephone authenticated by the authenticating unit is in a predetermined range from the information processing apparatus; a first changing unit which, if it is discriminated by the detecting unit that the authenticated cellular telephone is not in the predetermined range, changes a status retained by the application from a first status to a second status; and a second changing unit which, if it is discriminated by the detecting unit that the authenticated cellular telephone is in the predetermined range, changes the status retained by the application from the second status to the first status.

An embodiment of the present invention will be described with reference to the accompanying drawings.

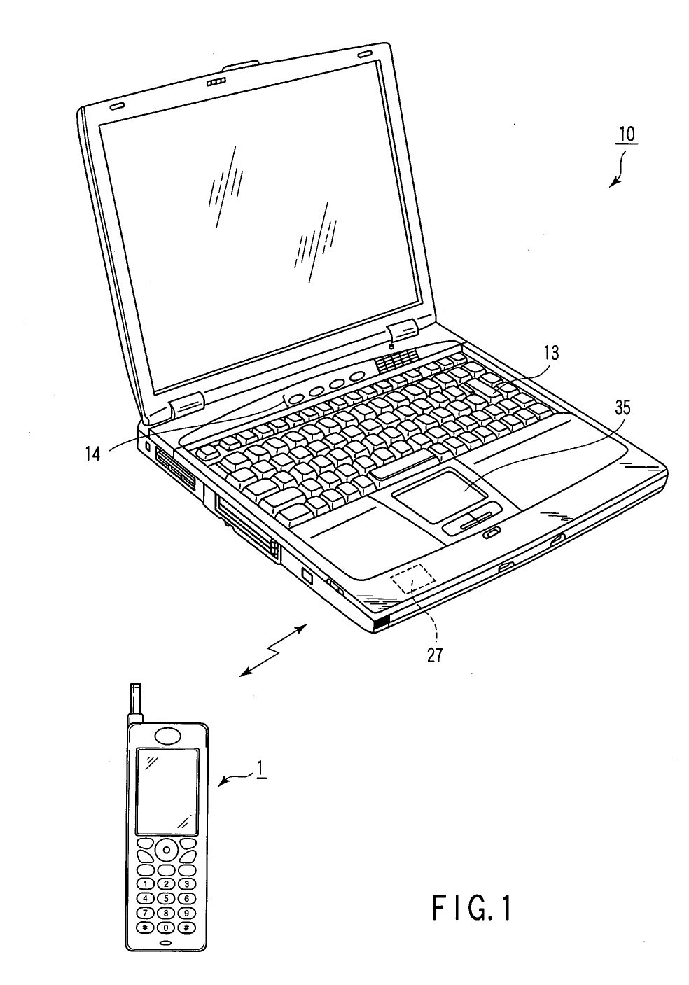

A main body of a computer 10 is a housing shaped in a thin box and comprises, on a top face thereof, a keyboard 13, a touch pad 35, two right and left buttons, various kinds of shortcut buttons for mailing and the like, a volume control button, a power button 14, a speaker and the like, as shown in FIG. 1. An optical drive and the like are provided on side faces of the main body. A Bluetooth™ communications unit 27 for executing short-distance wireless communications is built in the palm rest. For the short-distance wireless communications, Bluetooth™ is employed in this embodiment but the other wireless connection methods of wireless LAN and the like may be employed.

One of devices executing connection via the Bluetooth™ communications unit 27 is, for example, a cellular telephone 1 having a Bluetooth™ communications function.

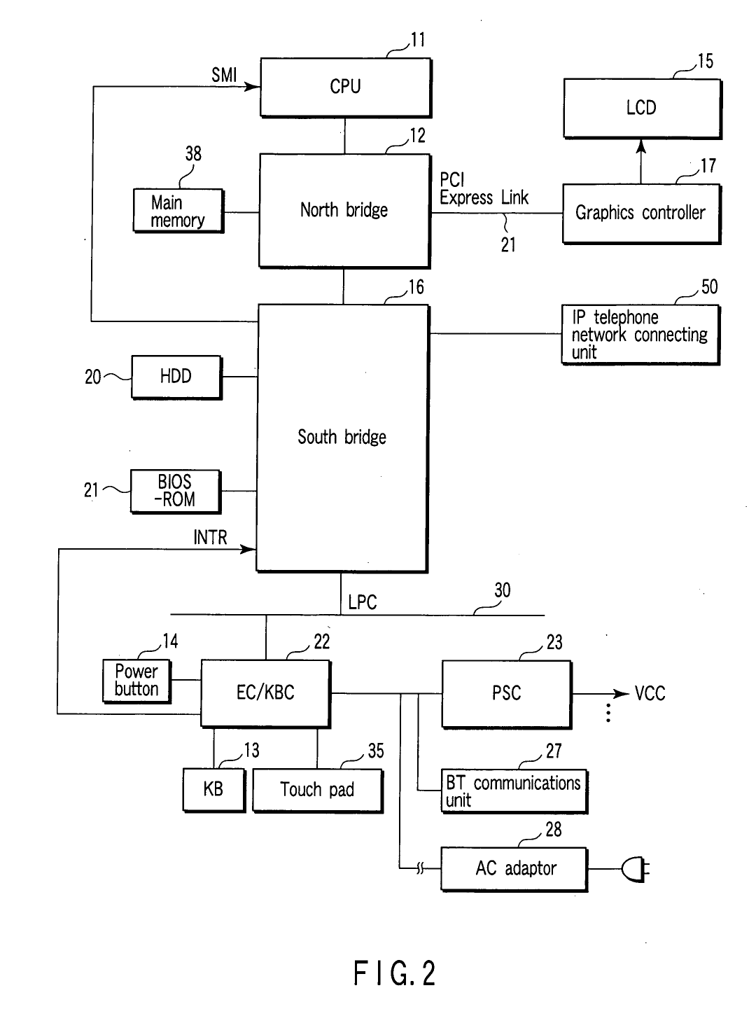

FIG. 2 is a block diagram showing a configuration of the computer 10.

As shown in the figure, the personal computer 10 comprises a CPU (Central Processing Unit) 11, a north bridge 12, a main memory 38, a graphics controller 17, a display unit (LCD) 15, a south bridge 16, a hard disk drive (HDD) 20, a BIOS-ROM 21, an embedded controller/keyboard controller IC (EC/KBC) 22, a power supply controller (PSC) 23, the keyboard (KB) 13, the touch pad 35, the Bluetooth™ communications unit (hereinafter called BT communications unit) 27 which establishes short-distance wireless communications, an IP (Internet Protocol) telephone network connecting unit 50 and the like. The HDD 20 stores a VOIP (Voice Over Internet Protocol)-associated application to be described later, telephone numbers of correspondents, and the like. The IP telephone connections are controlled via the IP telephone network connecting unit 50. A VOIP application program (hereinafter called VOIP application) 60 is conversation software operated with, for example, VOIP and may comprise a communications function such as a chat function.

Each of the north bridge 12, the graphics controller 17 and the south bridge 16 is a device (component) which is in conformity with the PCI EXPRESS standards. The communications between the north bridge 12 and the graphics controller 17 are executed over the PCI Express Link 21 arranged between the north bridge 12 and the graphics controller 17. Each of PCI EXPRESS links is a communications path composed of a serial interface, and includes an upstream lane and a downstream lane.

The CPU 11 is a processor controlling the operations of the computer, and executes various kinds of programs (operating system, VOIP application programs and the like) loaded on the main memory 38 by the HDD 20. The CPU 11 also executes the BIOS (Basic Input Output System) stored in the BIOS-ROM 21. The BIOS is a program for controlling the hardware. In addition, the BIOS has an SMI (System Management Interrupt) routine for dynamically permitting or prohibiting the execution of the Active State Power Management (ASPM) function defined under the PCI Express standards in accordance with the operation mode of the computer.

The north bridge 12 is a bridge device for making a connection between a local bus of the CPU 11 and the south bridge 16. A memory controller for controlling access to the main memory 38 is built in the north bridge 12. The north bridge 12 also has a function for executing communications with the graphics controller 17 over the PCI EXPRESS link 21.

The graphics controller 17 is a display controller which controls the LCD 15 employed as a display monitor of the computer. The south bridge 16 also controls each of the devices such as the BT communications unit 27 on an LPC (Low Pin Count) bus 30.

The embedded controller/keyboard controller IC (EC/KBC) 22 is a one-chip microcomputer on which an embedded controller for power management and a keyboard controller controlling the keyboard (KB) 13 and the touch pad 35 are integrated. The embedded controller/keyboard controller IC (EC/KBC) 22 has a function of controlling power-on/power-off of the computer 10, in cooperation with the power supply controller (PSC) 23, in response to the user's operation of the power button 24. Moreover, the embedded controller/keyboard controller IC (EC/KBC) 22 also has a function of detecting connection of an AC adaptor 28 to the computer or detachment of the AC adaptor 28 from the computer.

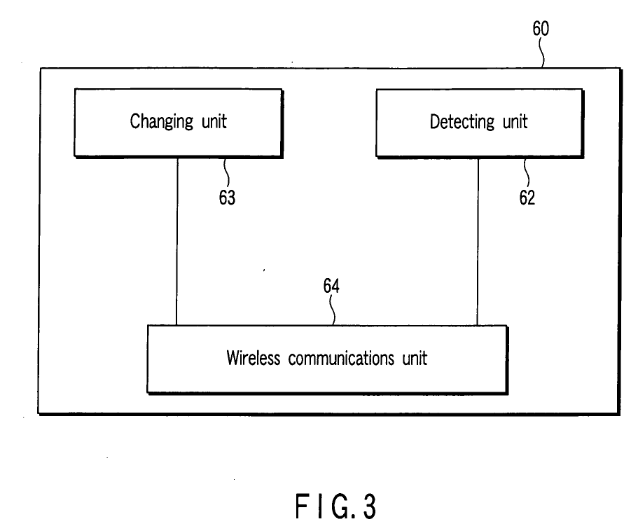

FIG. 3 is a block diagram showing functions of the VOIP application 60 loaded on the main memory 38 and executed by the CPU 11.

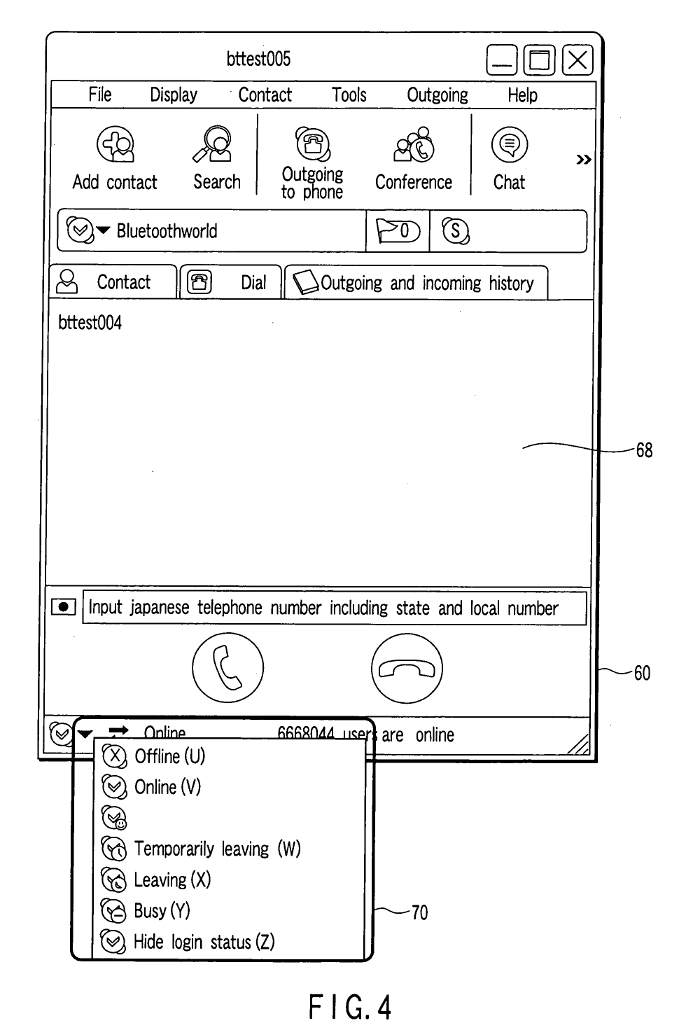

The VOIP application 60 comprises a detecting unit 62, a changing unit 63, and a wireless communications unit 64. The detecting unit 62 discriminates whether or not the short-distance wireless communications terminal such as the cellular telephone 1 or the like is detected by discriminating whether or not the cellular telephone is out of the wireless communications area via the Bluetooth™ communications unit 27. The changing unit 63 changes the status of the VOIP application 60, for example, “online”, “leaving” and the like (FIG. 4). The wireless communications unit 64 controls the Bluetooth™ short-distance wireless communications. If “online/conversation status” is changed to “leaving status” in accordance with the user's leaving, the connection request such as conversation request, chat connection request or the like can also be set from “permitted” to “prohibited”, in the VOIP application 60.

FIG. 4 shows an illustration of the VOIP application 60. The VOIP application 60 comprises a user display area 68 for displaying users recognized by the application, and a status changing unit 70. In general, the status changing unit 70 is changed manually by the user. In the present invention, however, if the user's leaving is detected, the status changing unit 70 is automatically changed to a preset status.

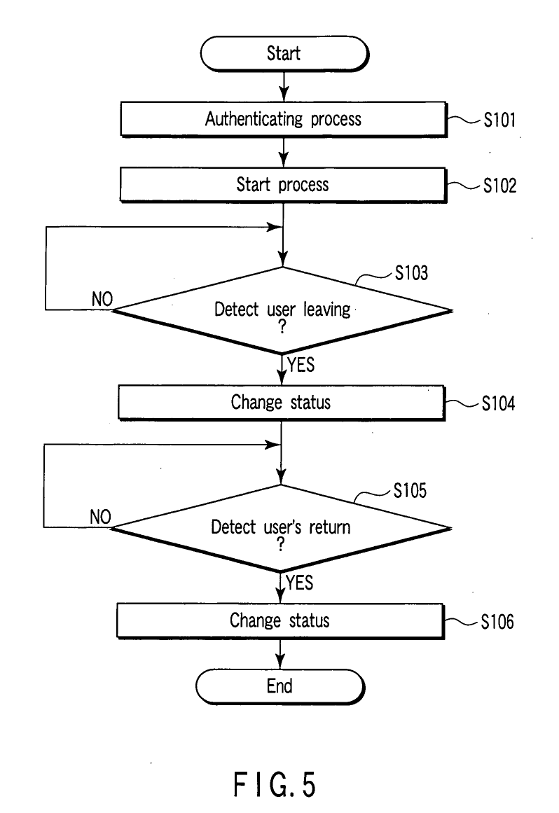

Next, a control method and program to which the information processing apparatus and status changing system according to the embodiment of the present invention will be described with reference to a flowchart of FIG. 5.

The Bluetooth™ communications unit 27 of the computer 10 executes an authenticating process together with the cellular telephone having the Bluetooth™ communications function as held by the user (step S101). After the authenticating process, the cellular telephone held by the user is registered in the computer 10 as the authenticated terminal.

The VOIP application 60 is activated and the process of the detecting unit 62 in the VOIP application 60 is started (step S102). The detecting unit 62 in the VOIP application 60 discriminates whether or not the user has left the seat (step S103). If the cellular telephone held by the user is out of the Bluetooth™ communications area, the detecting unit 62 in the VOIP application 60 discriminates that the user has left the seat (YES in step S103) and changes the status of the status changing unit 70 in the VOIP application 60 to “leaving” (step S104: cf. FIG. 4). Next, detecting unit 62 in the VOIP application 60 discriminates whether or not the user has returned to the seat (step S105). If the cellular telephone held by the user is in the Bluetooth™ communications area, the detecting unit 62 in the VOIP application 60 discriminates that the user has returned to the seat (YES in step S105), and changes the status of the status changing unit 70 in the VOIP application 60 to “online” (step S106: cf. FIG. 4).

In the above embodiment, the status change of the VOIP application is described. In response to the chat connection request, file transfer request, various script requests and the like received via the VOIP application, too, “permitted: online status” can be changed to “prohibited: leaving status” in accordance with the user's leaving.

Therefore, according to the present invention, the security of the computer can be maintained by prohibiting the connection request in the VOIP application during leaving without making the user conscious. In addition, while the VOIP application is utilized, the status of the VOIP application can be automatically changed in accordance with the user leaving the seat or returning to the seat, and the complicated process can be easily conducted.

As all the control processes of the present embodiment are implemented by the software, the same advantage as that of the present embodiment can be obtained with priority, by merely installing the program for executing the steps of the authentication control process in a general computer by a computer-readable storage medium.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus in which an application for connecting to a network and executing real-time communications is installed, comprising:
an authenticating unit which authenticates a cellular telephone equipped with a short-distance wireless communications unit, via the short-distance wireless communications unit;
a detecting unit which detects whether or not the cellular telephone authenticated by the authenticating unit is in a predetermined range from the information processing apparatus;
a first changing unit which, if it is discriminated by the detecting unit that the authenticated cellular telephone is not in the predetermined range, changes a status retained by the application from a first status to a second status; and
a second changing unit which, if it is discriminated by the detecting unit that the authenticated cellular telephone is in the predetermined range, changes the status retained by the application from the second status to the first status.

2. The apparatus according to claim 1, wherein the short-distance wireless communications unit is a communications unit employing a communications scheme defined by Bluetooth.

3. The apparatus according to claim 1, wherein the application executes at least one of communications and conversation using an Internet protocol.

4. The apparatus according to claim 1, wherein the first status is an online status indicating that conversation is being held and the second status is a status indicating that conversation is not being held.

5. The apparatus according to claim 1, wherein the detecting unit detects whether or not the apparatus is in the predetermined range, in accordance with a detectable range of the short-distance wireless communications unit.

6. The apparatus according to claim 1, wherein the detecting unit changes the status of the application from the first status to the second status after a predetermined time has elapsed.

7. A status changing system, comprising an information processing apparatus in which an application for connecting to a network and executing real-time communications is installed, and a cellular telephone equipped with a short-distance wireless communications unit,
the information processing apparatus comprising:
an authenticating unit which authenticates the cellular telephone, via the short-distance wireless communications unit of the cellular telephone;
a detecting unit which detects whether or not the cellular telephone authenticated by the authenticating unit is in a predetermined range from the information processing apparatus;
a first changing unit which, if it is discriminated by the detecting unit that the authenticated cellular telephone is not in the predetermined range, changes a status retained by the application from a first status to a second status; and
a second changing unit which, if it is discriminated by the detecting unit that the authenticated cellular telephone is in the predetermined range, changes the status retained by the application from the second status to the first status.

8. A program, urging a computer in which an application for connecting to a network and executing real-time communications is installed, to execute:
an authenticating step of authenticating the cellular telephone, via the short-distance wireless communications unit of the cellular telephone;
a detecting step of detecting whether or not the cellular telephone authenticated in the authenticating step is in a predetermined range from the information processing apparatus;
a first changing step of, if it is discriminated in the detecting step that the authenticated cellular telephone is not in the predetermined range, changing a status retained by the application from a first status to a second status; and
a second changing step of, if it is discriminated in the detecting step that the authenticated cellular telephone is in the predetermined range, changing the status retained by the application from the second status to the first status.
